(19) United States
(12) Patent Application Publication
(10) Pub. No.: US 2025/0179739 A1
(43) Pub. Date: Jun. 5, 2025

(54) CONDUCTING RAIL RETENTION SYSTEM

(71) Applicant: Caterpillar Inc., Peoria, IL (US)

(72) Inventors: Igor STRASHNY, Tucson, AZ (US); Roopa RAJESH, Tucson, AZ (US); Norbert T. AUFFARTH, Maxhuette-Haidhof (DE)

(73) Assignee: Caterpillar Inc., Peoria, IL (US)

(21) Appl. No.: 18/524,569

(22) Filed: Nov. 30, 2023

(51) Int. Cl. E01B 9/02

(52) U.S. Cl. CPC E01B 9/02

(57) ABSTRACT

A conducting rail retention system includes a plurality of conducting rails and a rail support assembly. The rail support assembly includes a support pole, the support pole including a top end and a bottom end, a support plate, the support plate being attached to the top end of the support pole, the support plate including a rail support portion on a top surface of the support plate, and a pair of rail clamps movable relative to one another from a rail unlock position to a rail interlock position securing the plurality of conducting rails to the support assembly.

### TECHNICAL FIELD

The present disclosure relates generally to a system for supplying electrical power to a mobile machine, and more specifically, to a rail retention system for supporting an electrically-conducting rail system supplying electrical power to the mobile machine.

### BACKGROUND

Mobile industrial machines, such as large earth-moving machines, present a unique problem in today's energy environment. These machines can be of substantial weight and can bear immense loads, thus requiring a significant amount of power to complete their functions. Existing industrial machines are commonly driven by internal combustion engines. However, such internal combustion engines have drawbacks in the form of fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present unique challenges. First, the use of hybrid or all-electric systems in an industrial capacity requires a significant investment in infrastructure, particularly due to the location of industrial worksites. While the use of electricity-conducting rails has been common solution for powering vehicles with predetermined routes or terrain (e.g., trains, subways, buses, etc.), freely-steerable industrial vehicles and worksites with uneven terrain have presented hurdles in the adoption of various electric power systems. As a result, most of the existing powered systems, such as the overhead trolley system, cannot be used in changing, remote, and uneven environments.

Concerns also arise in the ability to safely generate and conduct electricity to prevent dangerous occurrences (e.g., physical injury, electrical fires, etc.). As industrial vehicle routes may be subject to frequent change due to project needs, it is important for the systems providing the electrical power to offer a secure platform for use and have the ability to be quickly and reliably deployed.

An electric delivery system for providing electric power to a traveling vehicle is disclosed in International Patent App. Pub. No. WO 2020/186296 A1, published on Sep. 24, 2020 (“the '296 publication”). The system described in the '296 publication describes an electrical delivery system at a mine site for a moving vehicle where two conductors are anchored to relocatable roadside barriers. However, in order to charge the moving vehicle, the delivery system requires that a retractable arm must precisely engage with electrical connectors on or embedded within a horizontal channel or vertical protrusion of the roadside barriers. Thus, the disclosed systems of the '296 publication require roadside barriers be secured to the electrical power supply with complex and/or bulky conductor assemblies and attachments that may be difficult and costly to assembly, and may not provide the degree of flexibility needed at some job sites.

The system and method of the present disclosure may solve one or more of the problems set forth above and/or other problems in the art. The scope of the current disclosure, however, is defined by the attached claims, and not by the ability to solve any specific problem.

### SUMMARY

In one aspect, a conducting rail retention system includes a plurality of conducting rails and a rail support assembly. The rail support assembly includes a support pole, the support pole including a top end and a bottom end, a support plate, the support plate being attached to the top end of the support pole, the support plate including a rail support portion on a top surface of the support plate, and a pair of rail clamps movable relative to one another from a rail unlock position to a rail interlock position securing the plurality of conducting rails to the support assembly.

In another aspect, a conducting rail retention system includes a rail support assembly including a support pole, the support pole including a top end and a bottom end. The rail support assembly further includes a support plate, the support plate being attached to the top end of the support pole, the support plate including a rail support surface on a top surface thereof, and a pair of rail clamps movable relative to one another from a rail unlock position to a rail interlock position.

In yet another aspect, a conducting rail retention system includes a rail bracket assembly for connecting a support pole to a plurality of conducting rails. The rail bracket assembly includes a support plate including a rail support portion on a top surface thereof, and a pair of rail clamps movable relative to one another from a rail unlock position to a rail interlock position

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is an isometric view of an electric mobile machine coupled to a conducting rail power source, according to aspects of the present disclosure.

FIG. 2 is an angled view of a bracket assembly, according to one example.

FIG. 3 is a front view of a support plate of the bracket assembly shown in FIG. 2.

FIG. 4 is a front view of a clamping plate of the bracket assembly shown in FIG. 2.

FIGS. 5A and 5B are front views of the bracket assembly of FIG. 2 in an unlocked configuration and in a locked configuration, respectively.

FIGS. 6A and 6B are a front view of a bracket assembly in an unlocked configuration and in a locked configuration, respectively, according to another example.

FIGS. 7A and 7B are a front view of a bracket assembly in an unlocked configuration and in a locked configuration, respectively, according to yet another example.

FIGS. 8A and 8B are a front view of a bracket assembly in an unlocked configuration and in a locked configuration, respectively, according to another example.

FIGS. 9A and 9B are a front view of a bracket assembly in an unlocked configuration and in a locked configuration, respectively, according to another example.

FIGS. 10A and 10B are a front view of a bracket assembly in an unlocked configuration and in a locked configuration, respectively, according to another example.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

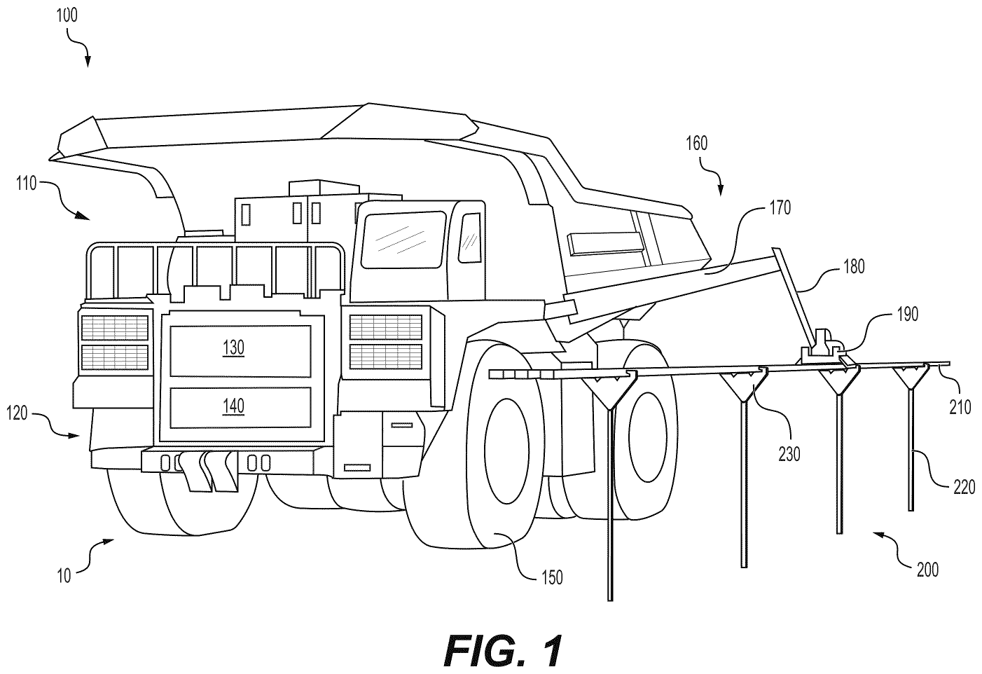

FIG. 1 depicts a mobile machine power system 100, which includes a mobile machine 110 and an electrically-conducting rail system 200 that provides electric current to the mobile machine 110. The mobile machine 110 is free-steering electric drive machine, such as an all-electric drive machine or a hybrid-electric drive machine (e.g., including an internal combustion engine). The mobile machine 110 may include an electric drive system 120 having one or more electric motors 130 and one or more battery systems 140. The electric drive system rotates a set of ground-engaging elements 150, such as tires or continuous tracks, for propelling and maneuvering the mobile machine 110. The mobile machine 110 is shown in the context of a mining truck which is commonly utilized for transporting ore in an open-pit mine environment. The present disclosure is not limited to a mining truck, however, and other types of mobile machines are within the scope of the present disclosure, including articulated trucks, asphalt pavers, backhoe loaders, cold planers, compactors, dozers, draglines, drills, rope shovels, excavators, forest machines, hydraulic mining shovels, material handlers, motor graders, off-highway trucks, pipelayers, road reclaimers, skid steer and compact track loaders, telehandlers, track loaders, underground mining dump loaders and trucks, wheel loaders, wheel tractor-scrapers, or other similar moble machines.

To electrically connect the mobile machine 110 to the electrically-conducting rail system 200, the mobile machine 110 includes a rail connection system 160 comprising a boom 170, a trialing or folding arm 180, and a power rail connector 190. The rail connection system 160 is selectively movable with respect to a frame of the mobile machine 110 between a retracted position and an extended, power-rail connected position. FIG. 1 shows the rail connection system 160 connected to the electrically-conducting rail system 200 in the extended position. While the rail connection system 160 can take different forms, in one exemplary configuration, the boom 170 may be pivotably connected to the frame of the mobile machine at a boom proximal end. The trailing arm 180 may be connected to a distal end of the boom 170, and is capable of being contracted or folded in a storage configuration when not in use. The trailing arm 180 may controllably adjust in length to connect to the electrically-conducting rail system 200. The power rail connector 190 may include multiple degrees of freedom to allow the power rail connector 190 to align and ride on top of the electrically-conducting rail system 200.

The rail connection system 160 may include electrically conductive components for delivering current from the electrically-conducting rail system 200 to the mobile machine 110. Suitable power electronics may be incorporated in the mobile machine 110 for purposes of power conditioning and distribution between and among the electrical drive system 120, including the at least one electrical motor 130, and/or other electrical components of the mobile machine. It may be appreciated by one having skill in the art that mobile machine 110 may utilize either include a hybrid drive system including, for example a prime mover such as an internal combustion engine and an energy storage system such as a battery system, or an all-electric drive system including, for example, only an energy storage system such as a battery system. The electrically-conducting rail system 200 may be applied to either system.

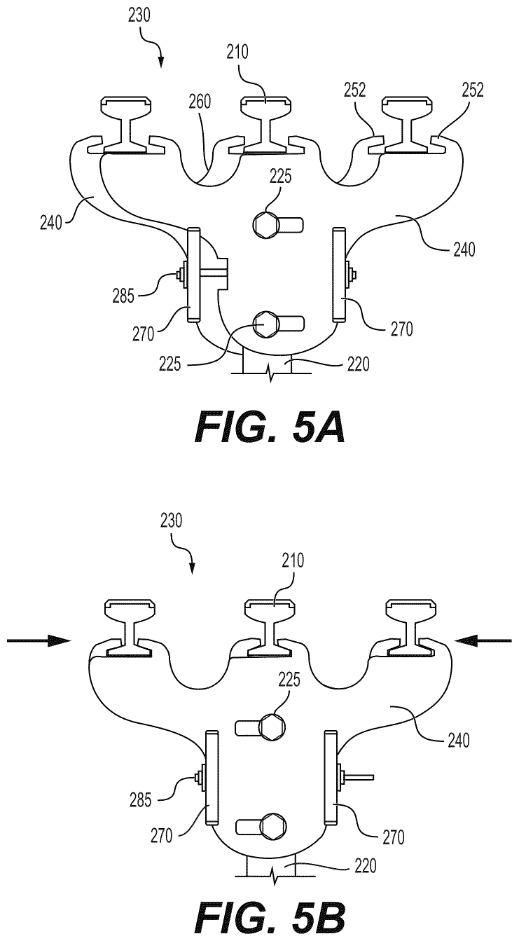

As shown in FIG. 1, the electrically-conducting rail system 200 includes a conducting rail retention system including a plurality of parallel conducting rails 210, such as three conducting rails 210, and a rail support assembly including a plurality of support poles 220 and a bracket assembly 230 for each support pole 220. The electrically-conducting rail system 200 may extend vertically from the ground, with support poles 220 and the bracket assembly 230 being connected together to support the conducting rails 210. During periods of operation, it is desirable to utilize the electrically-conducting rail system 200 to supply electrical power to the mobile machine 110. The timing, location, duration, and frequency of connections to electrically-conducting rail system 200 will depend upon various factors including how the mobile machine 110 is used, the route design and terrain of the worksite, and the design of the off-board electrical power system of which electrically-conducting rail system is a part. In the context of FIGS. 5A and 5B, 6A and 6B, 7A and 7B, 8A and 8B, 9A and 9B, and 10A and 10B, three conducting rails 210 are depicted; however, any number of conducting rails sufficient to suit the system's needs may be used.

The support poles 220 may be anchored directly in the ground as shown in FIG. 1, or may be coupled to traffic barriers (not show) or other structures that on or in the ground. The height of the support poles 220 may provide the conducting rails 210 at a consistent height-a safe distance above the ground, such as greater than eight feet, but not so tall as to be above the mobile machine 110 or even the boom 170 of the mobile machine 110. The support poles 220 may extend the electrically-conducting rail system 200 between approximately eight feet and fifteen feet above the ground. The support pole 220 may be made of a metal material, such as steel or aluminum. The support poles 220 may be placed in direct connect with one of the conducting rails 210 to function as an electrical ground for the electrically-conducting rail system 200.

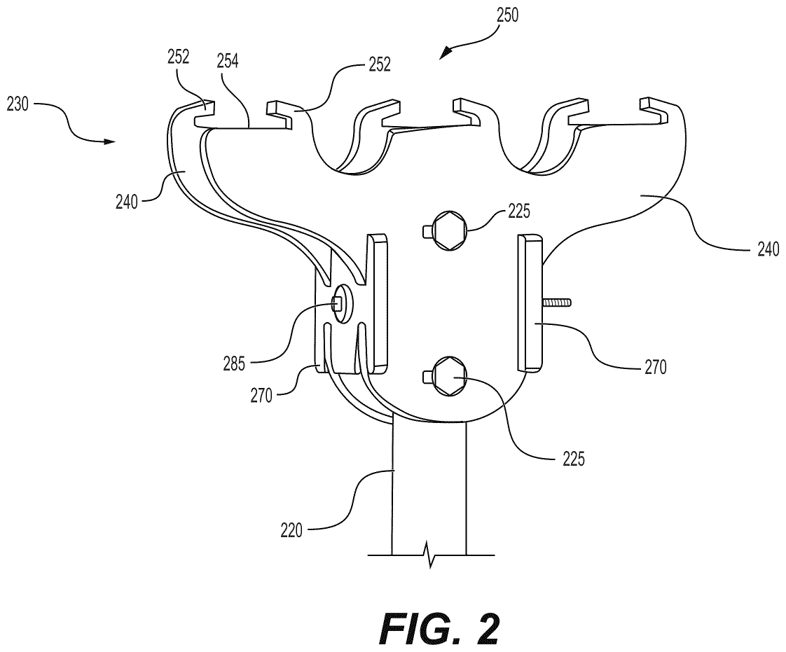

Referring now to FIG. 2, the individual bracket assemblies 230 include a pair of identical support plates 240 fastened on opposite sides of a support pole 220, a set of support pole fasteners 225 coupling the supports plates 240 to the support pole 220, a pair of clamping plates 270, and clamping plate fasteners 285. While not show, the support poles 220 include openings to accommodate the fasteners 225, 285.

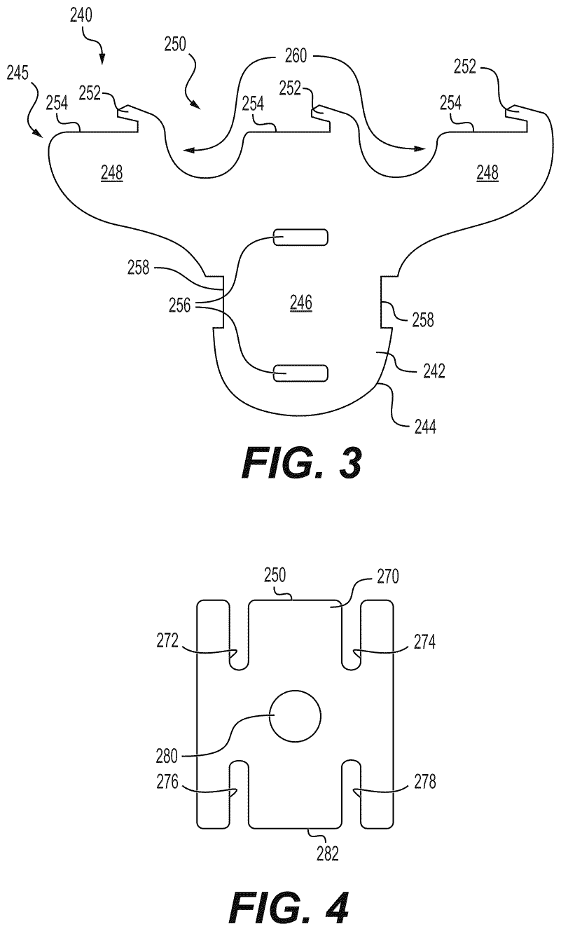

As noted above, the support plates 240 are identical to one another, but are attached on the support pole 220 in a flipped, reversed, or mirror orientation, as will be discussed in more detail below. With reference to FIG. 3, a single support plate 240 will now be discussed, with the description being the same for the other support plate 240 of the bracket assembly 230. Support plate 240 may include planar front and back sides 242, 244, a central base portion 246, and a wing portion 248 extending from each side of the base portion 246. A top of the base portion 246 and a top of the wing portions 248 together form a rail support portion 250. Rail support potion 250 includes a plurality of rail clamping members or rail clamps 252, configured to assist in retaining the conducting rails 210. For example, rail clamping members 252 may be shaped as hooks (as shown in FIG. 2), catches, clips, clasps, etc. As shown in FIG. 2, the support plate 240 is configured to support three conducting rails 210, and there are three rail clamping members 252, one for each conducting rail 210. Rail support portion 250 also includes a series of planar rail support surfaces 254 for receiving a bottom surface of the conducting rails 210. Bracket assembly 230 is configured to fixedly secure the conducting rails parallel to one another along a generally horizontal plane. Support plate 240 with rail clamping members 252 forms an asymmetric configuration about a vertical central axis.

Support plate 240 may also include one or more through slots 256 located in a central base portion 246 for receiving the support pole fasteners 225 coupling the supports plate 240 to the support pole. The support plate 240 may also include a pair of side notches 258 on each side surface of the base 246. The side notches 246 could be rectangularly shaped as shown in FIG. 2, or could have alternative shapes, and are configured to receive portions of the pair of clamping plates 270, as will be discussed in more detail below. The support plate 240 may also include a series of top notches 260 formed on a top surface of the support plate 240 and between and separating each of the clamping members 252. Thus, when configured for three conducing rails 210, support plate may include two top notches 260. While the top notches 260 are shown as rounded, concave notches, the top notches 260 could have an alternative shape. As will be described in more detail below, the top notches 260 allow for the power rail connector 190 to easily align and slide along the conducting rails without coming into contact with the bracket assembly 230, thereby preventing possible derailments of the power rail connector 190.

FIG. 3 also depicts the two through slots 256 of the identical support plates 240. These slots 256 may extend completely through the support plate 240, may be centrally located along a width of the support plate 240, and may be vertically aligned with one another as shown. As will be described in more detail below, the slots 256 may receive adjustable fasteners 225 (e.g. bolt-type fasteners, FIG. 2) to couple a pair of support plates 240 to corresponding through holes (not shown) in a support pole 220.

FIG. 4 depicts a singular clamping plate 270 of the pair of identical clamping plates 270 (FIG. 2) that are used to facilitate the securing or clamping of the conducting rails 210 to the support plates 240. The clamping plate 270 may have a generally H-shape. For example, clamping plate 270 may have an overall generally square shape with four slots 272-278 extending into the clamping plate 270. The four slots 274-278 may include two straight slots extending from a top surface and normal thereto, and two straight slots extending from a bottom surface and normal thereto. The slots include a length less than half the height of the clamping plate 270, and a width slightly larger than the thickness of support plates 240 so as to receive portions of the support plates 240. The clamping plate 270 may also include a center through hole 280. As will be described in more detail below, the through hole 280 may receive an adjustable fastener 285 (e.g. bolt-type fastener, FIG. 2) to couple a pair of clamping plates 270 through a corresponding through hole (not shown) in support pole 220.

The securing of conducting rails 210 to bracket assemblies 230 is shown in FIGS. 5A and 5B. It is noted that conducing rails 210 include a generally I-beam shape. Accordingly, rail clamping members 252 are shaped to correspond to the bottom portion of the I-beam shape of the conducing rails 210. Rail clamping members 252 could include a different shape in order to secure a conducting rail of a different shape than show.

As shown in FIG. 5A, identical support plates 240 are coupled to support pole 220 in a flipped or reversed orientation so as to provide opposing rail clamping members 252 on each side of a conducting rail 210. Such opposing clamping members 252 form a C-clamp configuration. Further, the length of through slots 256, along with loosened support pole fasteners 225, allow the support plates 240 to shift horizontally with respect to one another to minimize a distance between opposing clamping member 252, and thereby fixedly clamp conducting rails 210 to the support plates 240 (FIG. 5B). This movement between an expanded, unlocked, rail receiving position shown in FIG. 5A of the pair of support plates 240, and a locked or interlocked, rail clamped position shown in FIG. 5B, is provided or assisted by tightening a fastening member 285 extending between opposing and connected clamping plates 270. In doing so, the clamping plates get closer to one another, and the support plates 240 move from an offset position relative to one another in FIG. 5A to an aligned, or mostly aligned position as shown in FIG. 5B. Once in the rail clamped position shown in FIG. 5B, the support pole fasteners 225 can be tightened to fixedly secure the support plates 240 relative to the support pole, and further secure the support plates 240 relative to one another.

Other designs for shifting rail retention members have been contemplated in the present disclosure. Such other designs will now be discussed and the same elements will have the same reference number, and similar elements will have a reference number with a multiple of 100 added thereto. The discussion and details of elements above will fully and equally apply to the newly introduced similar element below.

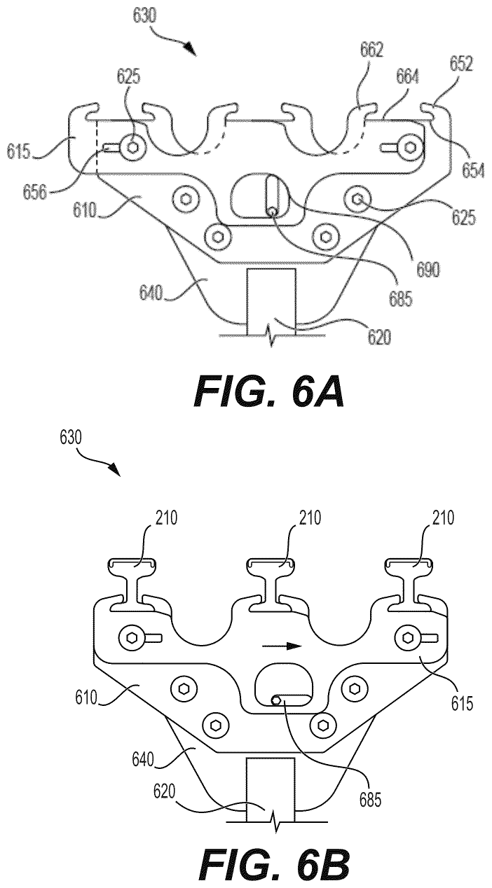

FIGS. 6A and 6B use a horizontally shifting member design similar to the design shown in FIGS. 2-5B. As shown in FIG. 6A, the bracket assembly 630 may include a support pole 620 that includes a support plate 640 fixedly coupled thereto. The support plate 640 can be integrally formed with the support pole 620, e.g. by welding, etc., and thus does not require separate fasteners. A base plate 610 is fixedly attached to the support plate 640 via a plurality of fasteners 625. The base plate 610 includes a plurality of conducting rail support surface 654 and associated plurality of rail clamping members 652. As shown in FIG. 6A, base plate 610 includes three rail support surfaces 654 and three rail clamping members 652. The bracket assembly 630 also includes a shifting plate member 615 that also includes a plurality (e.g., three) rail support surfaces 664 and rail clamping members 662. The shifting plate member 615 may be slidably attached to the base plate 610 via mechanical fasteners 625 that are fixed to base plate 610 and positioned in through slots 656, as shown in FIGS. 6A and 6B.

In order to secure the conducting rails 210 with rail clamping members 652 and 662, the shifting plate member 615 slides along through slots 656, and shifts from an unlocked configuration (FIG. 6A) to a locked configuration (FIG. 6B). A cam bolt 685, winged nut, or other similar fastener may be included to help shift and lock the shifting plate member 615 in position. For example, cam bolt 685 may rotatably extend from base plate 610 and be received in a corresponding hole 690 in shifting plate member 615 so that rotation of the cam bolt 685 rides along a surface of the hole 690 to shift the plate member 615 between the unlocked and locked positions. Once in a desired position, cam bolt 685 and fasteners 625 may be tightened to secure shifting plate member 615 in place. It is understood that the cam bold 685 and the corresponding hole 690 in shifting plate member 615 may be omitted.

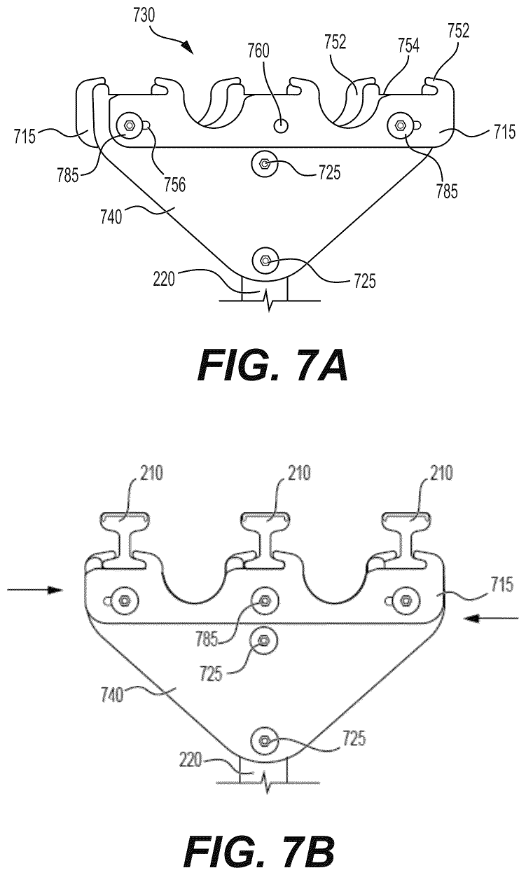

FIGS. 7A and 7B also incorporate sliding members in the bracket assembly 730. While FIGS. 6A and 6B utilize a base plate 610 and a single shifting member 615, the bracket assembly 730 of FIGS. 7A and 7B include a support pole 220, a single support plate 740, and a pair of identical shifting plate members 715 having a plurality of rail clamping members 752. The support plate 740 is attached to a top end of the support pole 220 with fasteners 725. The support plate 740 may include a plurality (e.g., three) U-shaped conducting rail support surfaces 754 at a top surface of the support plate 740.

The pair of shifting plate members 715 may be slidably secured to opposite sides of support plate 740 in a flipped or reversed orientation to one another. The shifting plate members 715 may include a pair of through slots 756 and a locking hole 760. Fasteners 785 may be fixed to support plate 740 through corresponding holes, and extend on each side of support plate 740 to attach the shifting plate members 715 to the support plate 740. The pair of shifting members 715 can slide relative to the support plate 740 via through slots 756 between a rail unlocked position (FIG. 7A) and a rail locked or interlocked position (FIG. 7B) where the rail clamping members 752 secure each conductive rail 210. Once in the rail locked position, a fastener can extend through the holes 760 in shifting plate members 715 and through a corresponding hole in support plate 740 to fixedly secure both shifting plate members 715 in position. It is noted that support plate 740 and/or shifting plate members 715 can form conducting rail support surfaces. Further, it is understood that hole 760 of shifting plate members 715, and corresponding fastener 785 may be omitted.

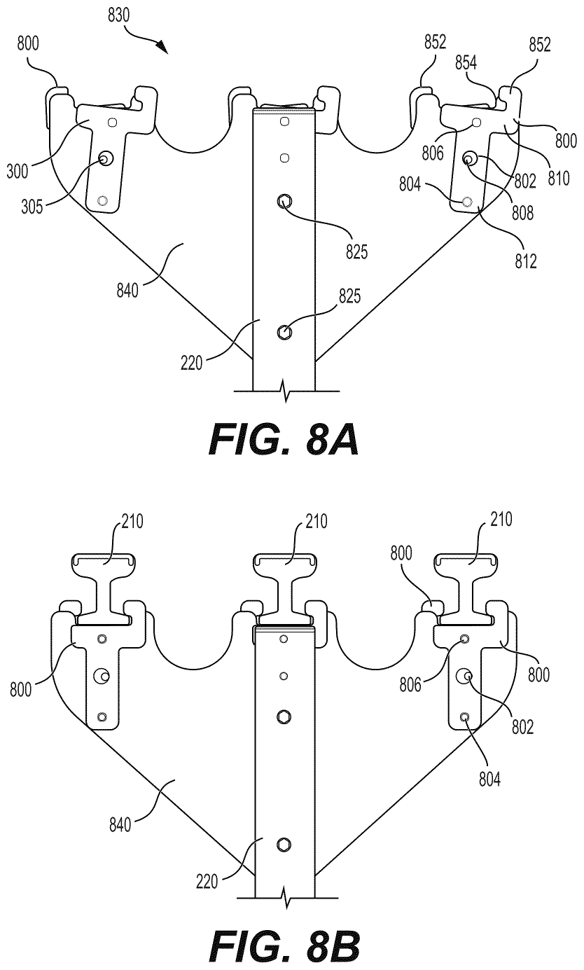

In another design, FIGS. 8A and 8B depict a bracket assembly 830 having a single support plate 840 that is attached, via fasteners 825, to the support pole 220. The support plate 840 may include a U-shaped conducting rail support portion 854, and a series of holes (not shown) for coupling a plurality of pivoting latches 800 to the support plate 840. The pivoting latches 800 may be plate-like structures having a general T-shape with a rail clamping member 852 at a top end. A plurality, e.g. three, pivoting latches 800 are secured on each side of the support plate 840. The pivoting latches 800 on each side of the support plate 840 are identical, but flipped or reversed in orientation so as to locate the rail clamping members 852 on opposite sides of a rail support portion 854. The T-shaped pivoting latches 800 may include a top (generally horizontal) beam 810 having a flat top surface portion that aligns with the conducting rail support surface 854. The T-shaped pivoting latches 800 may also include a bottom (generally vertical) beam 812 extending normal to the top beam. The bottom beam 812 may include a plurality of generally vertically aligned holes, including a lower hole 804, a mid-hole 802, and an upper hole 806. In the open, unlocked position shown in FIG. 8A, the pivoting latches 800 are secured to the support plate 840 via a fastener in lower hole 804, in a manner that allows for pivoting about lower hole 804. A pin or bolt 808 may be fixed to support plate 840 to extend through mid-hole 802 in a manner that allows limiting-range pivoting of the pivoting latch 800 between the unlocked position (FIG. 8A) and the locked position (FIG. 8B). In the unlocked position, the pivoting latch 800 is slightly angled with respect to vertical, and in the locked position, the pivoting latch 800 is generally vertical. Once both a front and back pivoting latch 800 is moved to the locked position, upper holes 806 align with a hole in support plate 840 and a fastener can be extended through the holes to fix the pivoting latch 800 in the locked position. As shown in FIGS. 8A and 8B, and noted above, support pole 220 in this embodiment and the other embodiments of this disclosure is coupled to a respective bracket assembly so that a top surface of the support pole 220 contacts a conducting rail 210 to form a ground connection.

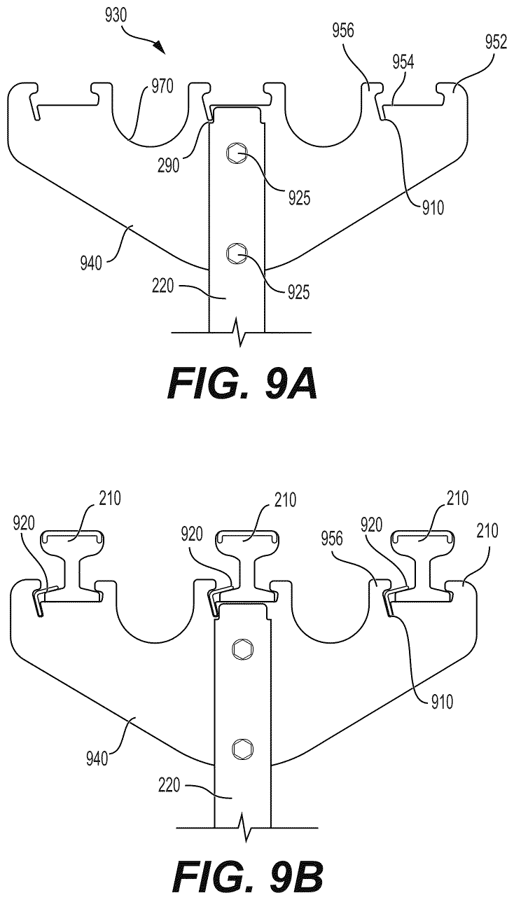

In another design, FIGS. 9A and 9B illustrate a bracket assembly 930 utilizing a single support plate 940. FIG. 9A shows an unlocked configuration. In this configuration, the support plate 940 may include a plurality (e.g., three) conducting rail support surfaces 954, a plurality of rail clamping members 952, and a plurality of insert grooves 910 located opposite the rail clamping members 952. In operation, as shown in FIG. 9B, a plurality of clip inserts 920 may be pressed into the insert grooves 910 to stabilize and retain the plurality of conducting rails 210. The plurality of clip inserts 920 frictionally lock a lower portion of the rails 210 and result in a locked configuration.

The clip inserts 920 may be formed of, for example, spring steel, and may include a first and second leg extending generally normal to one another. The insert grooves 910 extend below rail support surface 954 and at an acute angle with respect to rail support surface 954. As shown in FIG. 9B, the insert groove 910 may surround the clip insert 920 below the rail support surface 954, and the clip insert 920 may extend along a wall of a vertical column 956 of the support plate 940 along the entire first leg, and a portion of the second leg.

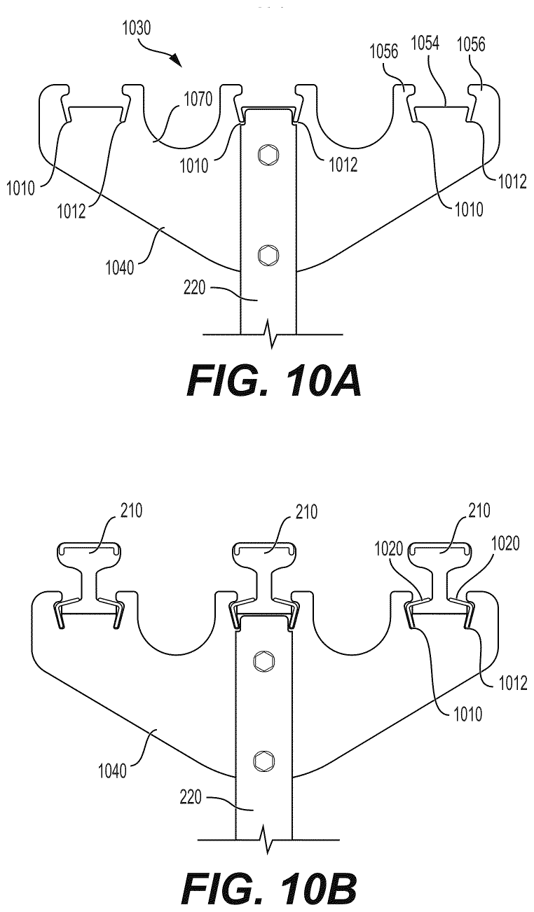

Like FIGS. 9A and 9B, the bracket assembly 1030 of FIGS. 10A and 10B similarly utilize a single support plate 1040 and clip inserts 1020. The clip inserts 1020 and associated insert grooves 1010 are the same as those discussed above with respect to FIGS. 9A and 9B, except two identical but reversed insert grooves 1010, 1012 are provided for each rail support surface 1054. Thus, support plate 1040 includes two insert grooves 1010, 1012 and associated clip inserts 1020 for retaining an individual conducting rail 210. The insert grooves 1010 oppose each other on opposite sides of the conducting rail support surface 1054, and between vertical columns 1056. Clip inserts 1020 are pressed into both insert grooves 1010, 1012 securing the lower portion of the conducting rail 210 to the bracket assembly 1030.

### INDUSTRIAL APPLICABILITY

The disclosed aspects of the bracket assembly system above can be used for quickly deploying and securely supporting an electrically-conducting rail system at an elevated height to charge a free-steering mobile machine on an industrial worksite.

In accordance with the present disclosure, the bracket assembly system for the dynamic charging system may provide for improved safety and security for a plurality of conducting rails, while also assisting in the rapid deployment of the electrically-conducting rail system along any route necessary on an industrial worksite. The rigidity of the bracket assemblies of the present disclosure may help prevent operator accidents and other worksite mishaps from resulting in potentially fatal consequences, and alleviate challenges that are currently present in hybrid or all-electric power systems. Finally, the disclosed bracket assemblies may require a minimum number of part, thus reducing assembly time and cost.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A conducting rail retention system, comprising:
a plurality of conducting rails; and
a rail support assembly, including:
a support pole, the support pole including a top end and a bottom end,
a support plate, the support plate being attached to the top end of the support pole, the support plate including a rail support portion on a top surface of the support plate, and
a pair of rail clamps movable relative to one another from a rail unlock position to a rail interlock position securing the plurality of conducting rails to the support assembly.

2. The rail retention system of claim 1, wherein the support plate is asymmetric about a central axis.

3. The rail retention system of claim 1, wherein the rail clamps are one of a shifting member or a pivoting member.

4. The rail retention system of claim 3, wherein the rail clamps form a C-clamp interlocking the plurality of conducting rails.

5. The rail retention system of claim 1, wherein the support plate includes a first support plate, and the rail support assembly includes a second support plate, the first and second support plates being identical and flipped with respect to one another, and attached on opposite sides of the support pole.

6. The rail retention system of claim 5, wherein each rail support assembly secures the plurality of rails to be parallel to one another.

7. The rail retention system of claim 6, wherein each rail support assembly secures at least three conducting rails to a support pole.

8. The rail retention system of claim 5, wherein the pair of identical support plates are secured to one another by a pair of clamping plates secured to opposite sides of the support plates.

9. The rail retention system of claim 1, wherein the pair of rail clamps include identical pivoting latches opposed to one another.

10. The rail retention system of claim 9, wherein each conductive rail is secured by a pair of the identical pivoting latches.

11. The rail retention system of claim 1, wherein the support pole is coupled to the support plate so that the support pole contacts a conducting rail.

12. A conducting rail retention system, comprising:
a rail support assembly, including:
a support pole, the support pole including a top end and a bottom end,
a support plate, the support plate being attached to the top end of the support pole, the support plate including a rail support surface on a top surface thereof, and
a pair of rail clamps movable relative to one another from a rail unlock position to a rail interlock position.

13. The rail retention system of claim 12, wherein a rail clamp of the pair of rail claims is formed on the support plate.

14. The rail retention system of claim 12, wherein the pair of rail clamps are separate members attached to the support plate.

15. The rail retention system of claim 12, wherein the pair of rail clamps are separate, pivoting latches attached to the support plate.

16. The rail retention system of claim 12, wherein the support plate is a first support plate, and the first support plate includes one of the rail claims, and the rail support assembly includes a second support plate including the other of the pair of rail claims.

17. A conducting rail retention system, comprising:
a rail bracket assembly for connecting a support pole to a plurality of conducting rails, the rail bracket assembly including:
a support plate including a rail support portion on a top surface thereof, and
a pair of rail clamps movable relative to one another from a rail unlock position to a rail interlock position.

18. The rail retention system of claim 17, wherein a rail clamp of the pair of rail claims is formed on the support plate.

19. The rail retention system of claim 17, wherein the pair of rail clamps are separate members attached to the support plate.

20. The rail retention system of claim 17, wherein the pair of rail clamps are separate, pivoting latches attached to the support plate.
